(19) United States
(12) Patent Application Publication
(10) Pub. No.: US 2026/0081343 A1
(43) Pub. Date: Mar. 19, 2026

(54) BASE STATION ANTENNA WITH INTERNAL MULTIPLEXER

(71) Applicant: OUTDOOR WIRELESS NETWORKS LLC, Richardson, TX (US)

(72) Inventor: Sammit Patel, Dallas, TX (US)

(21) Appl. No.: 19/321,681

(22) Filed: Sep. 8, 2025

Related U.S. Application Data
(60) Provisional application No. 63/695,434, filed on Sep. 17, 2024.

(51) Int. Cl. H01Q 1/24; H01Q 1/42; H01Q 5/20

(52) U.S. Cl. CPC H01Q 1/246; H01Q 1/42; H01Q 5/20

(57) ABSTRACT

An antenna includes: a radome with an internal cavity; upper and lower end caps attached adjacent opposite ends of the radome; a plurality of arrays of radiating elements mounted within the cavity of the radome; and at least one multiplexer with at least one connector mounted thereto, the at least one multiplexer being operatively connected with at least one of the plurality of arrays. The at least one multiplexer is mounted adjacent the lower end cap, and the at least one connector extends through the lower end cap.

### RELATED APPLICATION

The present application claims priority from and the benefit of U.S. Provisional Patent Application No. 63/695,434 , filed Sep. 17, 2024, the disclosure of which is hereby incorporated herein by reference in full.

### FIELD OF THE INVENTION

The present invention relates generally to telecommunication antennas, and more specifically to radio frequency base station antennas.

### BACKGROUND OF THE INVENTION

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three-sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns of radiating elements or columns in which some of the radiating elements are staggered horizontally to narrow the beamwidths of the generated antenna beams in the azimuth (horizontal) plane. Most modern base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to be connected to a pair of radios (or radio ports of a single radio) so that the linear array can transmit and receive RF signals at two orthogonal polarizations (i.e., an antenna beam is generated at each orthogonal polarization).

Each of the above-described linear arrays of dual-polarized radiating elements is coupled to two ports of a radio (one port for each polarization). An RF signal that is to be transmitted by the linear array is passed from the radio to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a 120° sector of a cell. Typically these linear arrays will have remote electronic tilt (“RET”) capabilities which allow a cellular operator to change, from a control center, the pointing angle of the generated antenna beams in the elevation (vertical) plane in order to change the size of the sector served by the linear array (since the more that the antenna beam is downtilted in the elevation plane, the less the area that is illuminated by the antenna beam, and hence the smaller the size of the area covered by the antenna beam). Since the antenna beams generated by the above-described 2G/3G/4G linear arrays are static antenna beams that only change in shape due to adjustments in the downtilt angle of the antenna beam, they are often referred to as “passive” linear arrays.

Cellular operators are currently upgrading their networks to support fifth generation (“5G”) cellular service. One important component of 5G cellular service is the use of multi-column “active” beamforming arrays that operate in conjunction with beamforming radios. The beamforming radios change the amplitudes and/or phases of the sub-components of a signal that is to be transmitted. The sub-components of the signal are passed to respective subsets of the radiating elements of the active beamforming array in order to dynamically adjust the size, shape and pointing direction of the antenna beams that are generated by the active beamforming array. These active beamforming arrays are typically formed using “high-band” radiating elements that operate in higher frequency bands, such as some or all of the 3.3-4.2 GHz and/or the 5.1-5.8 GHz frequency bands, although active beamforming radios may also be provided that operate in other frequency bands such as the upper portion (e.g., 2.5-2.7 GHz) of the mid-band frequency range. The radiating elements in each vertically-extending column of such an active beamforming array are typically coupled to a respective port of a beamforming radio so that each column of radiating elements is fed a different sub-component of the signal to be transmitted. The beamforming radio may be a separate device, or may be integrated with the active antenna array. As discussed above, the beamforming radio may adjust the amplitudes and phases of the sub-components of an RF signal that are fed to each port of the radio (and hence to each respective column of radiating elements in the multi-column beamforming array) in order to generate antenna beams that have narrowed beamwidths in the azimuth plane (and hence higher antenna gain). These narrowed antenna beams can be electronically steered throughout the sector by proper selection of the amplitudes and phases of the sub-components of the RF signal. In order to avoid having to increase the number of antennas at cell sites, 5G antennas that include such beamforming arrays also often include passive linear arrays that support legacy 2G, 3G and/or 4G cellular services.

FIGS. 1A and 1B illustrate a conventional base station antenna 100 that includes both passive low-band and mid-band linear arrays and a high-band active beamforming array. In particular, FIG. 1A is a front perspective view of the base station antenna 100, and FIG. 1B is a schematic front view of the base station antenna 100 with the radome thereof removed. In FIGS. 1A and 1B, the axes illustrate the vertical (V), horizontal (H) and forward (F) directions of the base station antenna system 100. In the description that follows, each antenna will be described using terms that assume that the antenna is mounted for use on a tower with the longitudinal axis L of the antenna extending along a vertical axis and the front surface of the antenna mounted opposite the tower pointing toward the coverage area for the antenna.

Referring to FIG. 1A, the base station antenna 170 has a tubular shape with a generally rectangular cross-section. The base station antenna 170 includes a radome 172, a top end cap 174 and a bottom end cap 176. A plurality of RF ports 178 in the form of RF connectors are mounted in the bottom end cap 176. The RF ports 178 extend through the bottom end cap 176 and are used to electrically connect the base station antenna 170 to external radios (not shown). The radome 172, top end cap 174 and bottom cap 176 may form an external housing for the antenna 170. An antenna assembly (FIG. 1B) is contained within the housing.

FIG. 1B is a schematic front view of the antenna assembly that is contained within the internal cavity of the housing of base station antenna 170. As shown in FIG. 1B, the antenna assembly includes a reflector 150. The reflector 150 may serve as both a structural component for the antenna assembly and as a ground plane and reflector for at least some of the radiating elements (discussed below) of antenna 150. The reflector 150 includes a generally flat metallic surface that extends in the longitudinal direction L of the antenna 170. Various mechanical and electronic components of base station antenna 170 (not shown) are mounted behind the reflector 150.

The antenna assembly further includes first and second low-band arrays 122-1, 122-2 of low-band radiating elements 124, first and second mid-band arrays 132-1, 132-2 of first mid-band radiating elements 134A, third through sixth mid-band arrays 132-3 through 132-6 of second mid-band radiating elements 134B, and a multi-column high-band array 142 of high-band radiating elements 144. The low-band arrays 122 and mid-band arrays 132 are each implemented as vertically-extending linear arrays of radiating elements. The low-band and mid-band linear arrays 122, 132 may support, for example, 2G, 3G and/or 4G cellular service. Each of the low-band and mid-band linear arrays 122, 132 are passive arrays that generate static antenna beams that provide coverage to a predefined coverage area (e.g., antenna beams that are each configured to cover a 120° sector of a base station), with the only change to the coverage area occurring when the electronic downtilt angles of the generated antenna beams are adjusted (e.g., to change the size of the cell).

The high-band radiating elements 144 are mounted in four columns in the lower center portion of the reflector 110 to form the multi-column array 142 of high-band radiating elements 144. Each column of the multi-column array 142 may be coupled to a pair of ports (one for each polarization) of a beamforming radio so that the multi-column array 142 operates as an active beamforming array that generates narrowed antenna beams that can be steered in the azimuth plane throughout the coverage area.

The low-band radiating elements 124 are configured to transmit and receive signals in the 617-960 MHz frequency range or a portion thereof (e.g., the 617-896 MHz frequency band, the 696-960 MHz frequency band, etc.). The first mid-band radiating elements 134A are configured to transmit and receive signals in the 1427-2690 MHz frequency range or a portion thereof (e.g., the 1427-1710 MHz frequency band, the 1427-2200 MHz frequency band, etc.). The second mid-band radiating elements 134B are configured to transmit and receive signals in the 1695-2690 MHz frequency range or a portion thereof (e.g., the 1710-2200 MHz frequency band, the 2300-2690 MHz frequency band, etc.). The second mid-band radiating elements 134B may have a different design than the first mid-band radiating elements 134A. The high-band radiating elements 144 are configured to transmit and receive signals in the 3300-4200 MHz frequency range or a portion thereof. The radiating elements 124, 134A, 134B, 144 are mounted to extend forwardly from the reflector 110.

The low-band and mid-band radiating elements 124, 134A, 134B may each be implemented as dual-polarized radiating elements that each include first and second radiators that are configured to transmit and receive RF energy at orthogonal polarizations. For example, the low-band and mid-band radiating elements 124, 134A, 134B may be implemented as slant −45°/+45° cross-dipole radiating element that include a −45° dipole radiator and a +45° dipole radiator that are arranged to form a cross when the radiating elements 124, 134A, 134B are viewed from the front. The dipole radiators of each low-band and mid-band radiating element 124, 134A, 134B are mounted on a feed stalk (not visible in FIGS. 1A and 1B) that passes RF signals between the dipole radiators and an associated feed network.

It may be desirable to provide additional configurations for antennas and antenna assemblies.

### SUMMARY OF THE INVENTION

As a first aspect, embodiments of the invention are directed to an antenna. The antenna comprises: a radome with an internal cavity; upper and lower end caps attached adjacent opposite ends of the radome; a plurality of arrays of radiating elements mounted within the cavity of the radome; and at least one multiplexer with at least one connector mounted thereto, the at least one multiplexer being operatively connected with at least one of the plurality of arrays. The at least one multiplexer is mounted adjacent the lower end cap, and the at least one connector extends through the lower end cap.

As a second aspect, embodiments of the invention are directed to an antenna comprising: a radome with an internal cavity; upper and lower end caps attached adjacent opposite ends of the radome; a plurality of arrays of radiating elements mounted within the cavity of the radome; a triplexer unit comprising two triplexers, each of the triplexers having two 4.3/10 connectors mounted thereto, each of the triplexers being operatively connected with at least one of the plurality of arrays; and first and second diplexers, each of the diplexers having a 4.3/10 connector mounted thereto, each of the diplexers being operatively connected with at least one of the plurality of arrays. The triplexer unit and the first and second diplexer units are mounted adjacent the lower end cap, wherein each of the 4.3/10 connectors of the triplexer unit and each of the 4.3/10 connectors of the first and second diplexer units extends through the lower end cap.

### BRIEF DESCRIPTION OF THE FIGURES

FIG. 1A is a front perspective view of a conventional base station antenna that includes both passive 2G/3G/4G linear arrays and an active beamforming array.

FIG. 1B is a schematic front view of the conventional base station antenna of FIG. 1A with the radome removed.

FIG. 2 is a front view of a base station antenna according to embodiments of the invention with the radome removed.

FIG. 3 is partial front perspective view of the base station antenna of FIG. 2 with the radome removed.

FIG. 4 is a partial bottom perspective view of the base station antenna of FIG. 2, with the lower end cap shown as transparent.

FIG. 5 is a bottom perspective view of the lower end cap of the base station antenna of FIG. 2.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

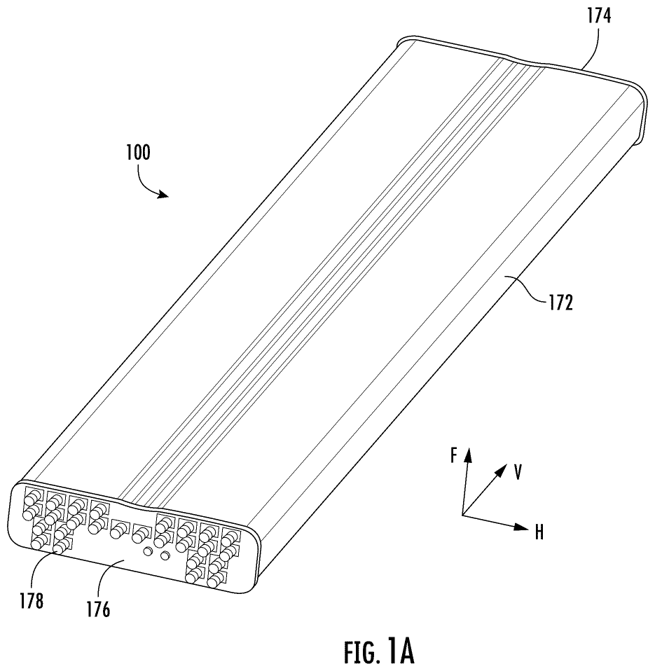

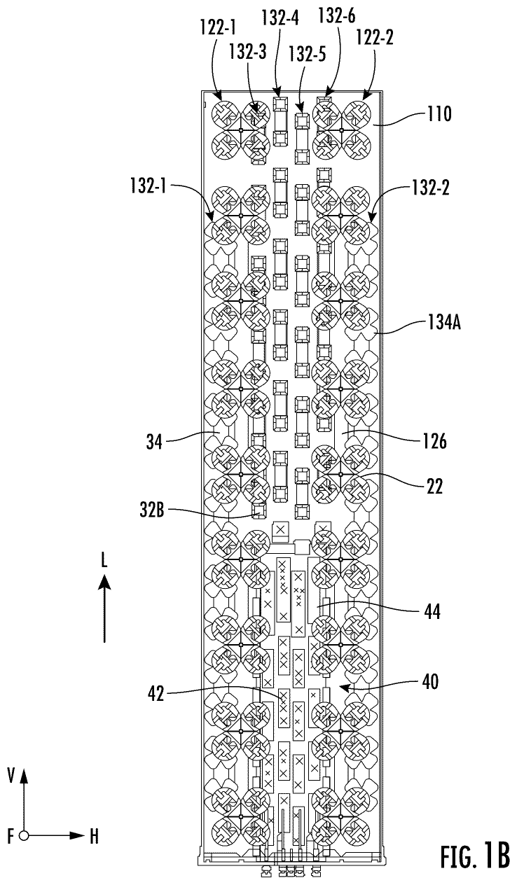

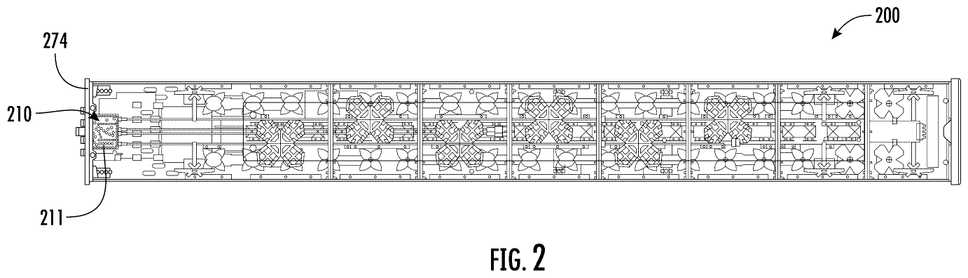

Referring now to the drawings, an antenna according to embodiments of the invention is designated broadly at 200 and illustrated in FIGS. 2-5. The antenna 200 is similar to the antenna 100 of FIGS. 1A and 2B, with the exception that the antenna 200 includes one triplexer unit 210 and two diplexers 220 mounted at the lower end of the antenna 200 within the radome, and further includes a lower end cap 274 that is configured to provide external ports for interconnection of the triplexer unit 210 and diplexers 220 with corresponding cables. These components are described in greater detail below.

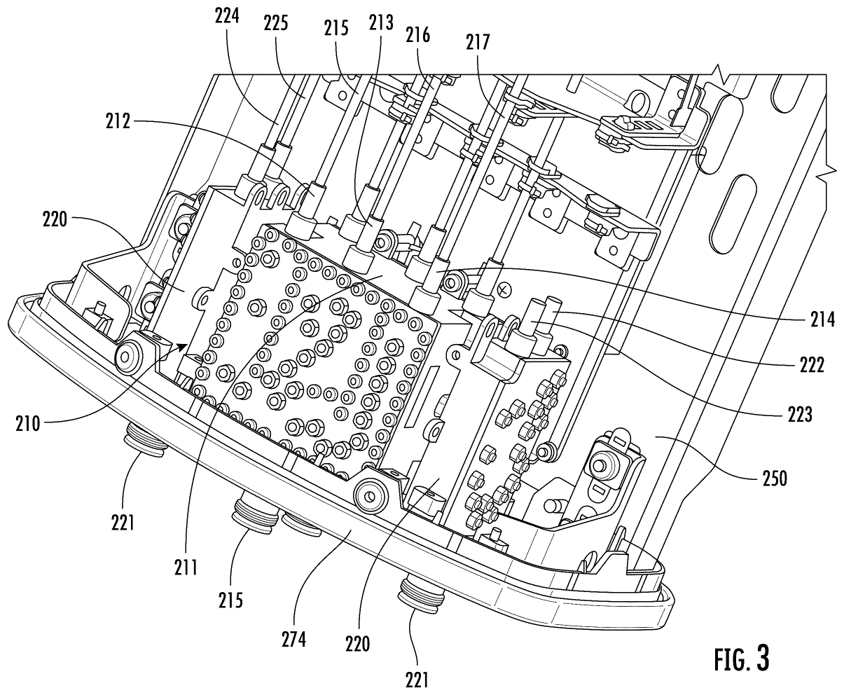

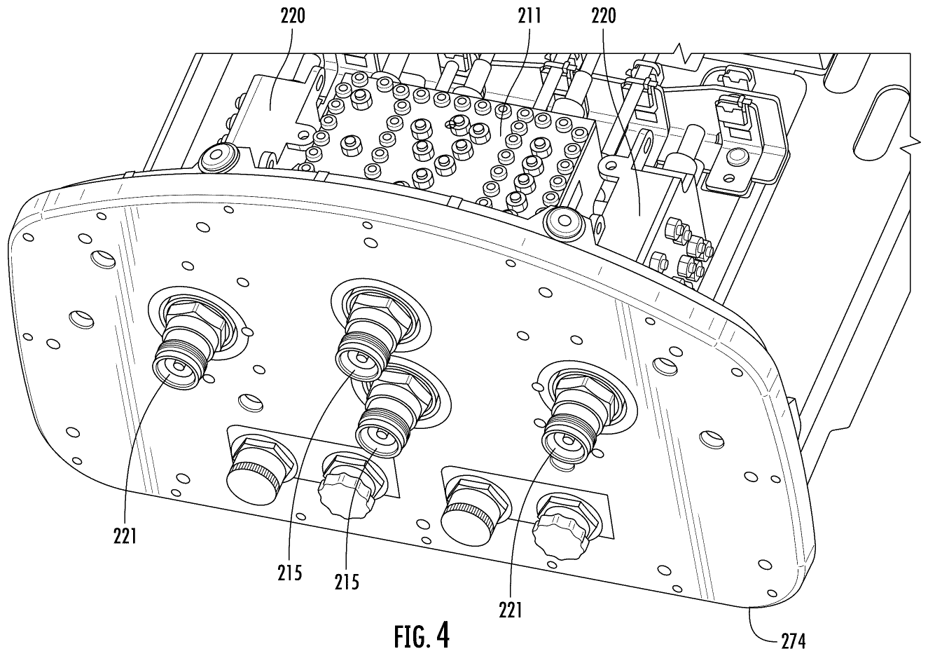

As shown in FIGS. 2 and 3, the triplexer unit 210 is mounted generally centrally within the lower end of the antenna 200 to the reflector 250 of the antenna 200. The triplexer unit 210 is constructed as two triplexers 211 integrated into a single unit (i.e., the individual triplexers 211 are presented in a stacked arrangement within a single integrated housing). Best seen in FIG. 3, each triplexer 211 has one low-beam port 212, one mid-beam port 213, and one high-beam port 214 as outputs. Best seen in FIG. 4, each triplexer 211 also has one 4.3/10 RF connector 215 as an input port. Cables 217-219 are routed from the ports 212-214 to the appropriate locations within the antenna 200.

Still referring to FIGS. 3 and 4, each of the diplexers 220 is mounted on the reflector 250 on a respective side of the triplexer unit 210. Each diplexer 220 has a 4.3/10 RF connector as an input port 221, and mid-beam and high-beam output ports 222, 223 with cables 224, 225 routed therefrom to appropriate locations within the antenna 200.

Other than the details discussed above, the triplexers 211 and diplexers 220 are of convention construction and operation and need not be discussed in detail herein.

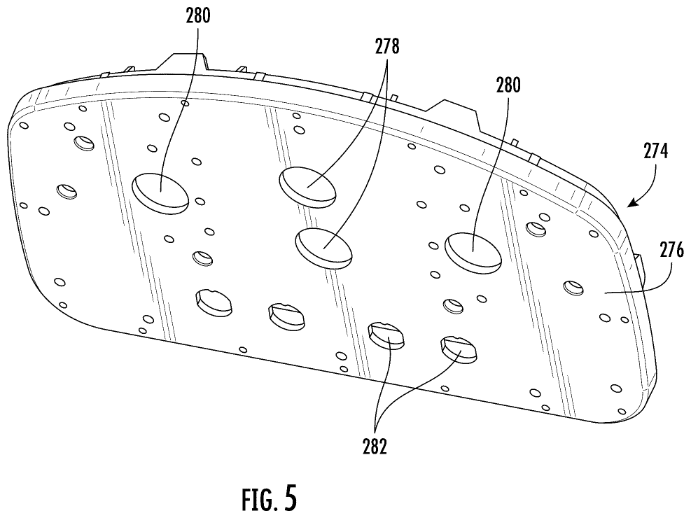

Referring now to FIG. 5, the lower end cap 274 is shown therein. The lower end cap 274 (typically formed of a polymeric material) has a main panel 276 that includes, inter alia, two holes 278 in its central portion and two holes 280 that are located on opposite sides of the holes 278. In addition, four holes 282 are aligned adjacent one edge of the lower end cap 274.

As can be seen in FIG. 4, in which the lower end cap 274 is shown as being transparent, the connectors 215 of the triplexer unit 210 extend through the holes 278, where they can be easily connected cables with mating 4.3/10 connectors. Also, the connectors 221 of the diplexers 220 extend through respective holes 280, where they also can be easily connected cables with mating 4.3/10 connectors. Connectors for AISG communications extend through the holes 282. Positioning the triplexer unit 210 and diplexers 220 within the antenna 200 so that their connectors 278, 280 extend through the lower end cap 274 can save significantly on space.

Base station antennas having internally mounted diplexers or triplexers are known in the art. In these conventional base stations, the cables that provide RF signals from the bottom of the tower to the base station antenna connect to RF connector ports that are mounted in the bottom end cap of the antenna. The RF connector ports may comprise, for example, a double-sided 4.3/10 connector that is configured so that a 50 ohm coaxial cable can be releasably connected to each side of the connector. Additional coaxial cables are provided inside these conventional base station antennas that connect each RF connector port to a respective input port on the diplexer or triplexer.

The conventional approach doubles the number of RF connectors required, which increases the weight and cost of the base station antenna. The conventional approach also requires additional coaxial jumper cables to connect the RF connector ports in the bottom end cap to the RF connector ports on the triplexer/diplexer. This increases part count, requires additional connectors on the ends of the coaxial jumper cables, and increases the insertion loss. Moreover, each cable-to-connector port connection is a potential source of passive intermodulation (“PIM”) distortion, and thus the increased number of connections provides more opportunity for PIM distortion. As described above, pursuant top embodiments of the present invention, the RF connector ports on the triplexers and/or on the diplexers may extend through respective openings in the bottom end cap to serve as the RF connector ports of the base station antenna. This eliminates the need for separate RF connector ports in the bottom end cap and for coaxial jumper cables.

The antenna 200 may be well-suited for use in environments (e.g., flagpoles and the like) in which limited space may be available, and for which minimizing or reducing the number of external cables may be desirable. As one example, three antennas 200 may be mounted on a flagpole, and for each antenna 200 only four signal-carrying cables are attached (two cables to the connectors 215, and one cable to each of the connectors 221). These cables are routed from the antenna 200 to a quadplexer that is mounted on the ground (e.g., within a cabinet) adjacent a radio. This arrangement can eliminate the need for external diplexers and triplexers adjacent the antenna as may be required for prior antenna configurations.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention.

What is claimed is:

1. An antenna, comprising:
a radome with an internal cavity;
upper and lower end caps attached adjacent opposite ends of the radome;
a plurality of arrays of radiating elements mounted within the cavity of the radome; and
at least one multiplexer with at least one connector mounted thereto, the at least one multiplexer being operatively connected with at least one of the plurality of arrays;
wherein the at least one multiplexer is mounted adjacent the lower end cap, and wherein the at least one connector extends through the lower end cap.

2. The antenna defined in claim 1, wherein the at least one connector is a 4.3/10 connector.

3. The antenna defined in claim 1 wherein the at least one multiplexer is a diplexer.

4. The antenna defined in claim 1, wherein the at least one multiplexer is a triplexer.

5. The antenna defined in claim 1, wherein the at least one multiplexer comprises two diplexers and a triplexer, and wherein the at least one connector comprises one connector for the each of the diplexers and two connectors for the triplexer.

6. The antenna defined in claim 1, wherein the plurality of arrays includes low-band, mid-band and high-band radiating elements.

7. The antenna defined in claim 1, further comprising a reflector within the cavity, and wherein the at least one multiplexer is mounted on the reflector.

8. An antenna, comprising:
a radome with an internal cavity;
upper and lower end caps attached adjacent opposite ends of the radome;
a plurality of arrays of radiating elements mounted within the cavity of the radome;
a triplexer unit comprising two triplexers, each of the triplexers having two 4.3/10 connectors mounted thereto, each of the triplexers being operatively connected with at least one of the plurality of arrays; and
first and second diplexers, each of the diplexers having a 4.3/10 connector mounted thereto, each of the diplexers being operatively connected with at least one of the plurality of arrays;
wherein the triplexer unit and the first and second diplexer units are mounted adjacent the lower end cap, and wherein each of the 4.3/10 connectors of the triplexer unit and each of the 4.3/10 connectors of the first and second diplexer units extends through the lower end cap.

9. The antenna defined in claim 8, wherein the plurality of arrays includes low-band, mid-band and high-band radiating elements.

10. The antenna defined in claim 8, further comprising a reflector within the cavity, and wherein the at least one multiplexer is mounted on the reflector.
